(19) United States
(12) Patent Application Publication
(10) Pub. No.: US 2023/0092140 A1
(43) Pub. Date: Mar. 23, 2023

(54) UNIFIED DATA SOLUTION FOR GEOGRAPHIC INFORMATION SYSTEM DATA PROCESSING

(71) Applicant: Transglobal Holdings, Inc., Fort Worth, TX (US)

(72) Inventors: John Ratliff, Fort Worth, TX (US); Jerry Cavitt, Fort Worth, TX (US); Colten Shinn, Fort Worth, TX (US); Dane Patrick, Fort Worth, TX (US); Sean Siegel, Fort Worth, TX (US); Chris Warren, Fort Worth, TX (US); Panpiroon Punnakanta, Fort Worth, TX (US)

(21) Appl. No.: 17/934,417

(22) Filed: Sep. 22, 2022

Related U.S. Application Data
(60) Provisional application No. 63/247,053, filed on Sep. 22, 2021.

(51) Int. Cl. G06Q 10/06; G06F 16/25; G06F 16/29

(52) U.S. Cl. CPC G06Q 10/06313; G06F 16/254; G06F 16/29

(57) ABSTRACT

A server system obtains geospatial data collected from a field device and associated with a first project, wherein the data is obtained in accordance with a code list specifying a plurality of data values associated with a plurality of projects including the first project; parses the geospatial data in accordance with one or more quality control operations; classifies the parsed geospatial data; selects a first extract-transform-load (ETL) tool of a plurality of ETL tools in accordance with the identified project type; processes, using the selected ETL tool, the parsed geospatial data into a first data scheme; and uploads the first data scheme to a geospatial information system (GIS) database for display in a user interface of a web application that integrates the geospatial data with non-spatial data corresponding to the first project.

### TECHNICAL FIELD

This application relates generally to computer technology and data processing techniques, including but not limited to methods and systems for integrating and processing geographic information system data.

### CROSS-REFERENCE TO RELATED APPLICATIONS

This application claims the benefit of U.S. Provisional Patent Application No. 63/247,053 filed Sep. 22, 2021 entitled “Unified Data Solution for Geographic Information System Data Processing”, which is incorporated by reference herein in its entirety.

### BACKGROUND

The land acquisition and surveying sectors support projects relating to, for example, land leases, right-of-way agreements, surveys for wells and pipelines, seismic mapping, and geographic information system (GIS) mapping. Such projects typically involve the collection of data from multiple data sources. Therefore, complications may be encountered regarding the collection, processing, curating, and display of such data. Such complications are compounded when the people and entities who collect the data, process the data, and use the data are geospatially spread out, making it difficult to maintain projects, assets, data, and finances.

### SUMMARY

This disclosure describes a unified data solution for the processing and display of data collected from multiple sources in the land acquisition and surveying sectors. The data solution described herein integrates data from a plurality of independent sources (sometimes referred to as data silos), and provides streamlined access to the integrated data in a novel and useful manner.

In one aspect, a method is implemented at one or more servers, wherein each of the one or more servers comprising one or more processors and memory. The method includes obtaining geospatial data collected from a field device and associated with a first project, wherein the data is obtained in accordance with a code list specifying a plurality of data values associated with a plurality of projects including the first project; parsing the geospatial data in accordance with one or more quality control operations; classifying the parsed geospatial data, including identifying a project type of the first project based on one or more characteristics of the parsed geospatial data; selecting a first extract-transform-load (ETL) tool of a plurality of ETL tools in accordance with the identified project type; processing, using the selected ETL tool, the parsed geospatial data into a first data scheme; uploading the first data scheme to a geospatial information system (GIS) database, including storing the first data scheme in the GIS database as a GIS record; linking one or more non-spatial project deliverable documents to the GIS record in the GIS database, wherein the non-spatial project deliverable documents are associated with the first project; and joining one or more project controls to the GIS record in the GIS database.

In some implementations, the method further includes joining one or more project controls to the GIS record in the GIS database; creating one or more map exchange document (MXD) files corresponding to the GIS record; publishing the GIS record from the one or more MXD files to one or more map services; configuring a web application including the one or more map services; and creating a transform application based on the web application, wherein the transform application comprises a user interface including map data associated with the map services, and a selectable user interface element, wherein the selectable user interface element corresponds to a selectable portion of the map data and includes (i) spatial data associated with the GIS record, and (ii) a link to the one or more non-spatial project deliverable documents associated with the GIS record.

In some implementations, the geospatial data includes topographical data.

In some implementations, the data values of the code list include one or more of coordinates, equipment identification data, technician identification data, and temperature data.

In some implementations, identifying the project type of the first project includes determining a type of job that was done based on a dataset associated with the parsed geospatial data.

In some implementations, identifying the project type of the first project includes determining that the first project is a topography project, an as-built project, or a scan file.

In some implementations, linking the one or more non-spatial project deliverable documents to the GIS record includes creating a link in the GIS database between (i) a first table including coordinates associated with the first data scheme of the GIS record, and (ii) a second table including a pointer to the one or more non-spatial project deliverable documents.

In some implementations, the one or more non-spatial project deliverable documents include ancillary data corresponding to an asset associated with the first project.

In some implementations, the one or more project controls include data that is associated with each of the plurality of projects

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a system diagram of a data processing environment in accordance with some implementations.

FIG. 2 is a flow diagram of a data processing method in accordance with some implementations.

FIGS. 3A-3G are flow diagrams of a data lifecycle associated with the method depicted in FIG. 2 in accordance with some implementations.

FIG. 4A-4E are diagrams of geographic information system visualization interfaces in accordance with some implementations.

### DETAILED DESCRIPTION

Implementations of the inventive concepts described in this disclosure are directed to providing a unified data solution for the processing and display of data collected from multiple sources in the land acquisition and surveying sectors. Examples of such data may include data corresponding to land systems, track systems, legal systems, project systems, and/or spatial systems. Providers, processors, and users of such data may be spread out geospatially, making it difficult for users to maintain their projects, assets, data, and finances. A front end (sometimes referred to as a portal), as described herein, is configured to provide a platform for clients to access projects and data associated with such projects (sometimes provided by third party data sources) all in one place (e.g., in a single window pane of a user interface), rather than being scattered across multiple platforms and data silos. The following disclosure describes various systems and methods for integrating the aforementioned data silos.

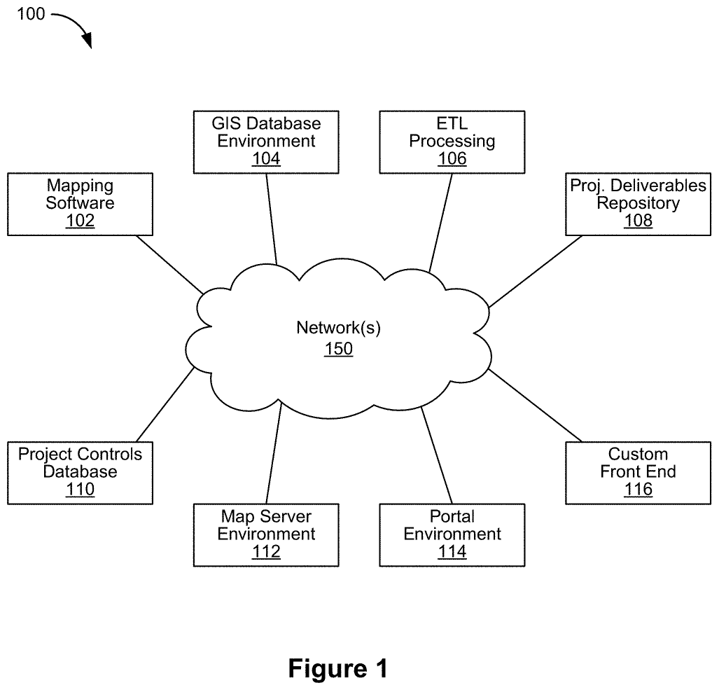

FIG. 1 is a system diagram of a data processing environment 100 in accordance with some implementations. Data processing environment 100 includes a plurality of modules 102-116 communicatively coupled by one or more networks 150. Each module may have associated hardware, software, and/or firmware (a variation, subset, or hybrid of hardware and/or software).

The term “hardware” includes at least one “processing unit,” “processor,” “computer,” “programmable apparatus,” and/or other known or yet to be discovered technology capable of executing instructions or steps.

The term “software” includes at least one “program,” “subprogram,” “series of instructions,” or other known or yet to be discovered hardware instructions or hardware-readable program code. Software may be loaded onto hardware (or firmware) to produce a “machine,” such that the software executes on the hardware to create structures for implementing the functions described herein. Further, the software may be loaded onto the hardware (or firmware) so as to direct the mobile-device-to-machine payment processing system (and components thereof) to function in a particular manner described herein or to perform a series of operational steps as described herein. “Hardware” may have software (e.g., programs and apps) loaded thereon. The phrase “loaded onto the hardware” also includes being loaded into memory associated with or accessible by the hardware.

The term “memory” is defined to include any type of hardware (or other technology)-readable media (also referred to as computer-readable storage medium) including, but not limited to, attached storage media (e.g., hard disk drives, network disk drives, servers), internal storage media (e.g., RAM, ROM, EPROM, FLASH-EPROM, or any other memory chip or cartridge), removable storage media (e.g., CDs, DVDs, flash drives, memory cards, floppy disks, flexible disks), firmware, and/or other known or yet to be discovered storage media. Depending on its purpose, the memory may be transitory and/or non-transitory.

Appropriate “messages,” “communications,” “signals,” and/or “transmissions” (that includes various types of information and/or instructions including, but not limited to, data, commands, bits, symbols, voltages, currents, electromagnetic waves, magnetic fields or particles, optical fields or particles, and/or any combination thereof) over appropriate “communication paths,” “transmission paths,” and other means for signal transmission including any type of connection between two or more of the modules in data processing environment 100 may be used as appropriate to facilitate controls and communications.

The terms “programs” and “subprograms” are defined as a series of instructions that may be implemented as software (i.e. computer program instructions or computer-readable program code) that may be loaded onto a computer to produce a “machine,” such that the instructions that execute on the computer create structures for implementing the functions described herein or shown in the figures. Further, these programs and subprograms may be loaded onto a computer so that they can direct the computer to function in a particular manner, such that the instructions produce an article of manufacture including instruction structures that implement the function specified in the flow chart block or blocks. The programs and subprograms may also be loaded onto a computer to cause a series of operational steps to be performed on or by the computer to produce a computer implemented process such that the instructions that execute on the computer provide steps for implementing the functions specified in the flow chart block or blocks. The phrase “loaded onto a computer” also includes being loaded into the memory of a computer or server or a memory associated with or accessible by the computer or server. Separate, albeit interacting, programs and subprograms may be associated with the modules 102-116 of data processing environment 100, and these programs and subprograms may be divided into smaller subprograms to perform specific functions.

The communication network(s) 150 are configured to convey “messages,” “communications,” “signals,” and/or “transmissions,” which include various types of information and/or instructions including, but not limited to, data, commands, bits, symbols, voltages, currents, electromagnetic waves, magnetic fields or particles, optical fields or particles, and/or any combination thereof. One or more communication protocols (e.g., any of WiFi, Bluetooth, ZigBee, Z-Wave, 6LoWPAN, Thread, 4G, 5G, and the like) may be used to implement the “communications,” “signals,” and/or “transmissions” including, for example, transmitters, receivers, and transceivers. For example, hard-wired communications (e.g., wired serial communications) may use technology appropriate for hard-wired communications, short-range communications (e.g., Bluetooth) may use technology appropriate for close communications, and long-range communications (e.g., GSM, CDMA, Wi-Fi, or the like) may use technology appropriate for remote communications over a distance.

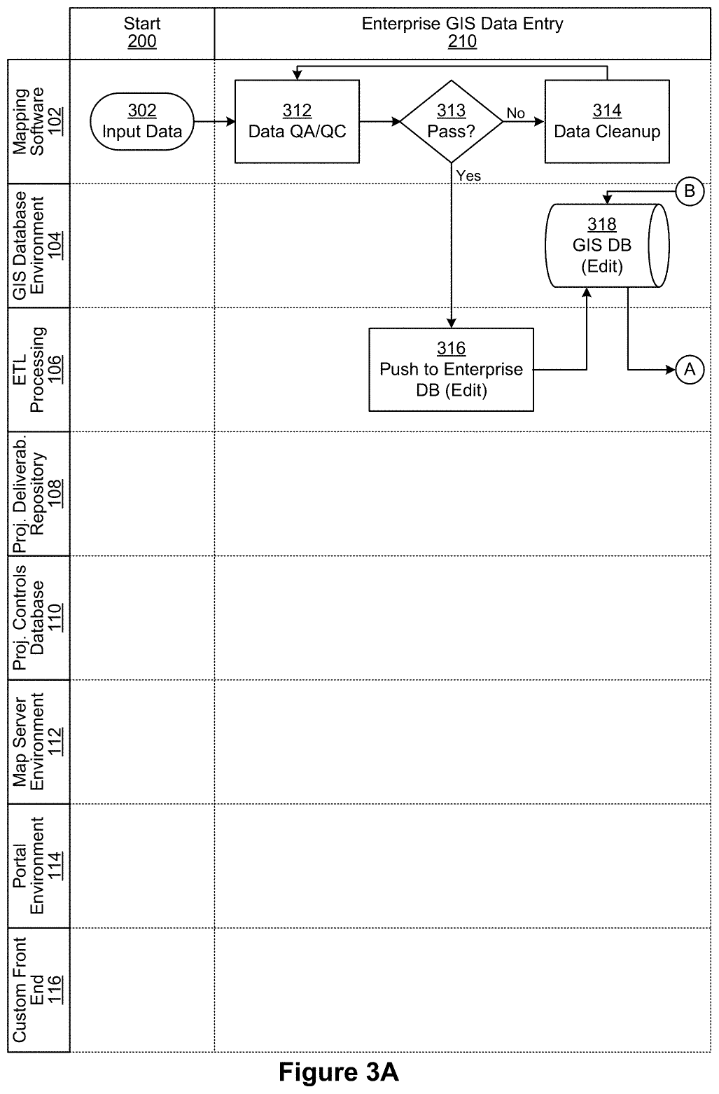

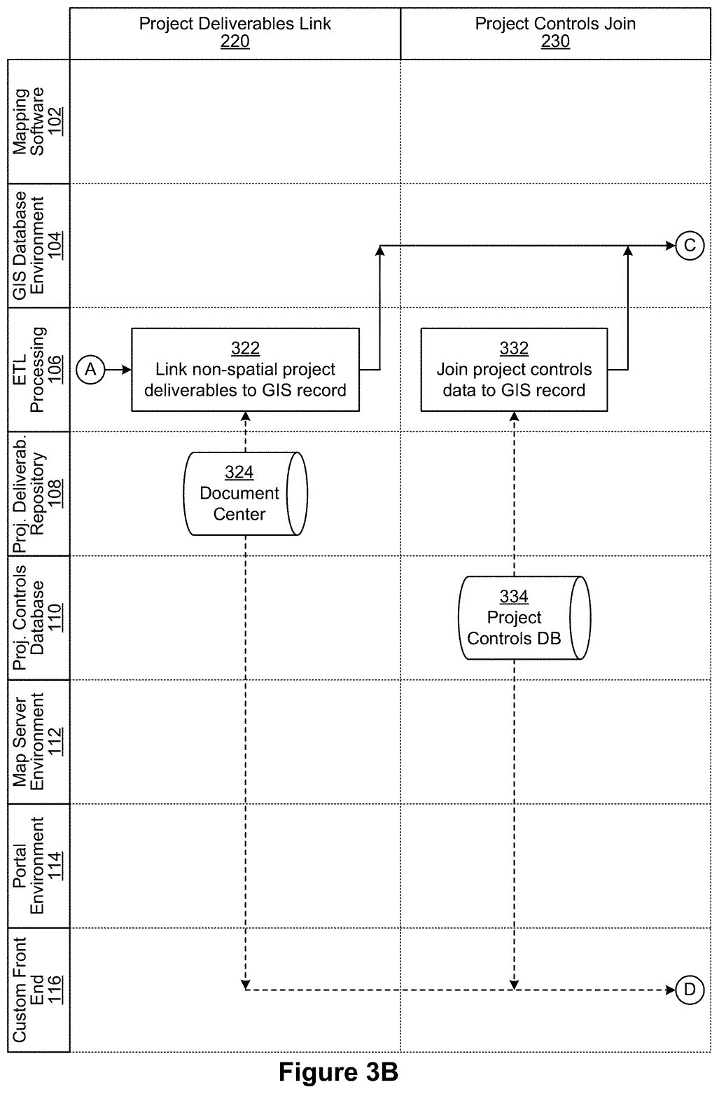

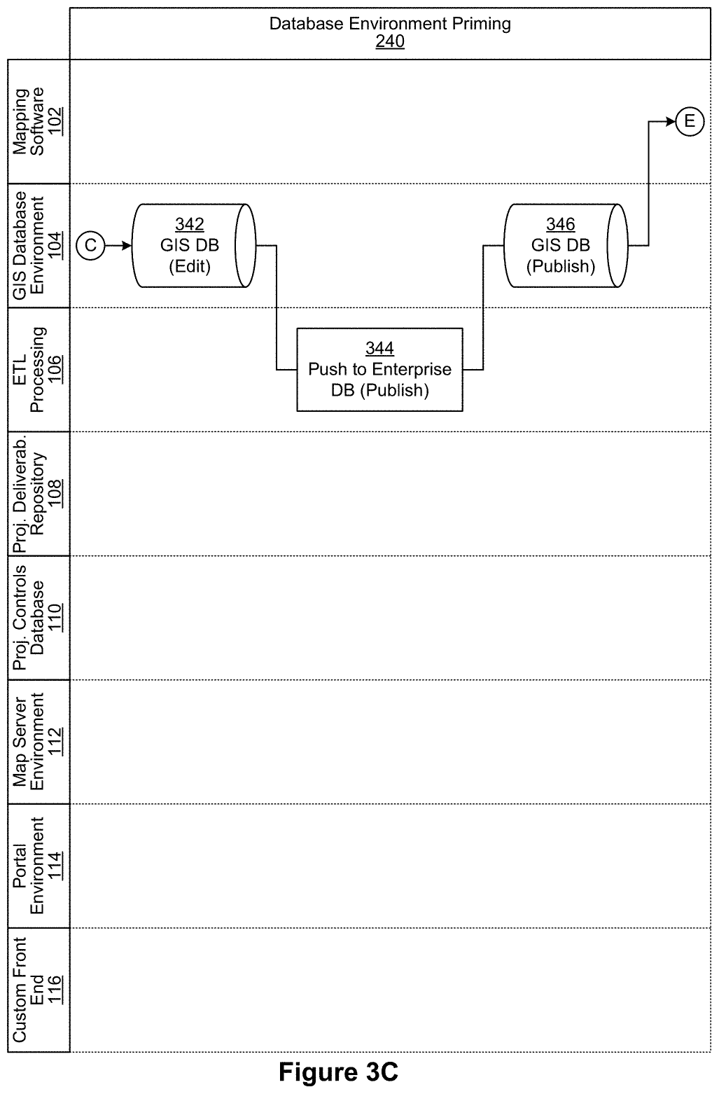

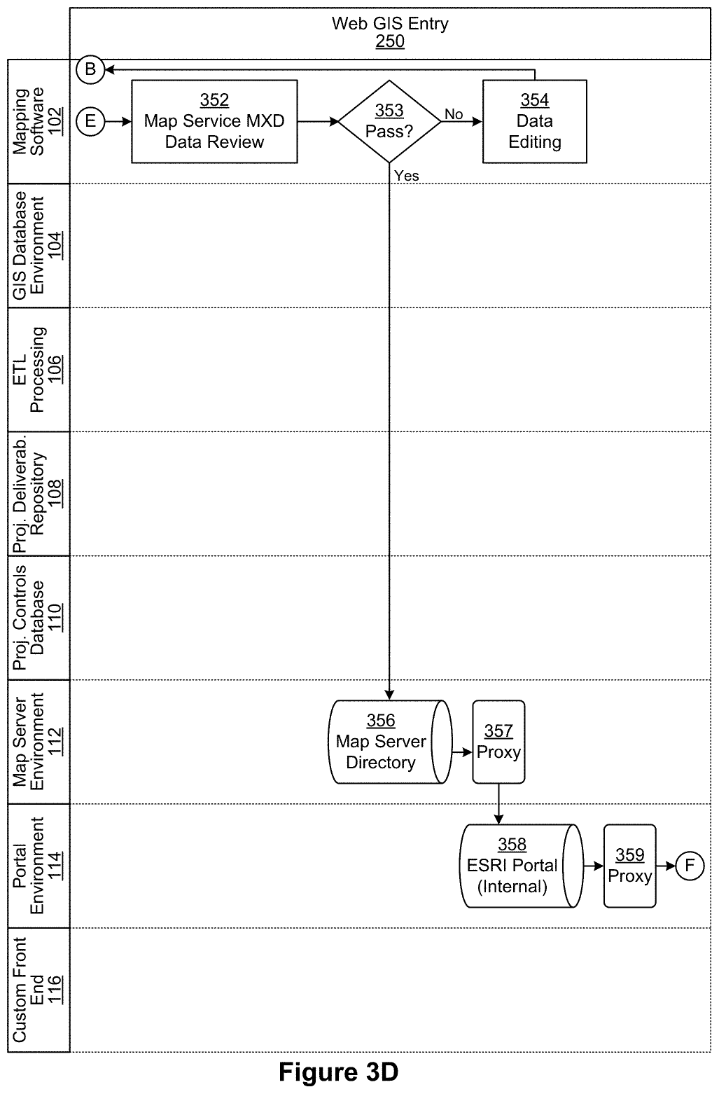

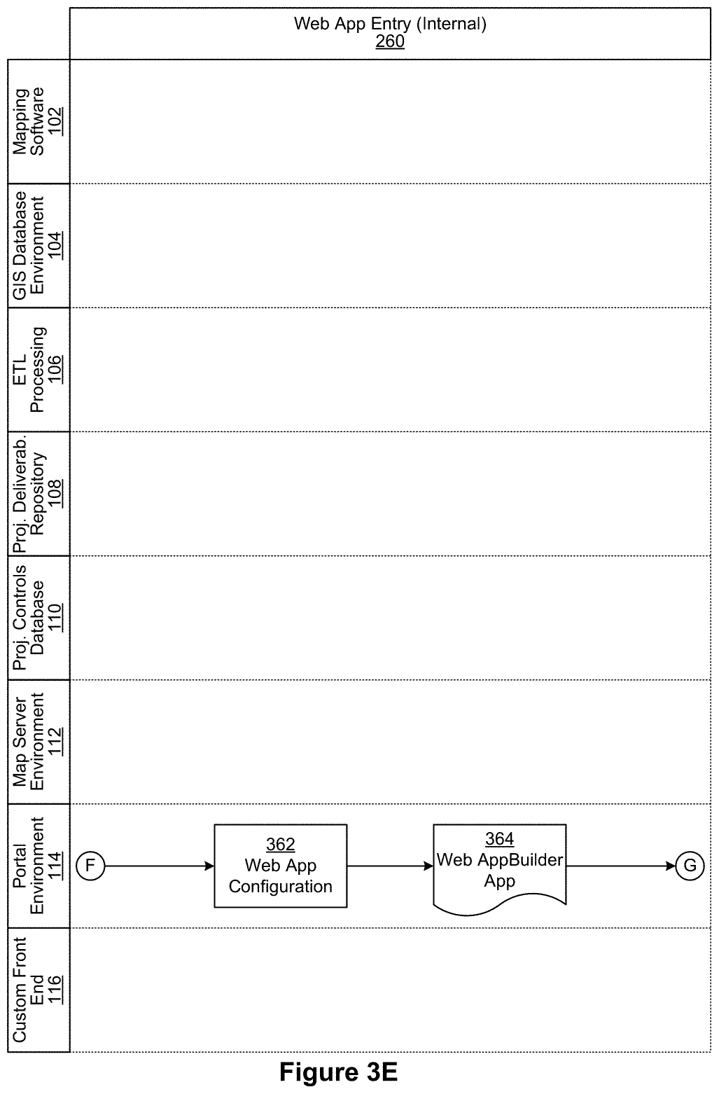

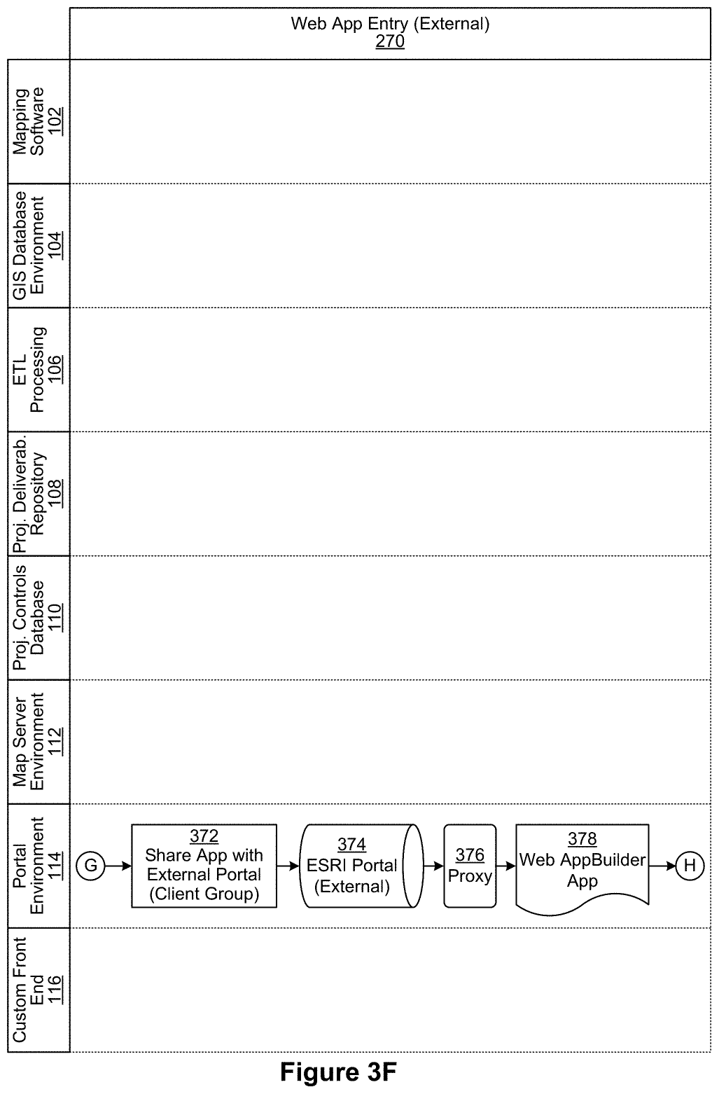

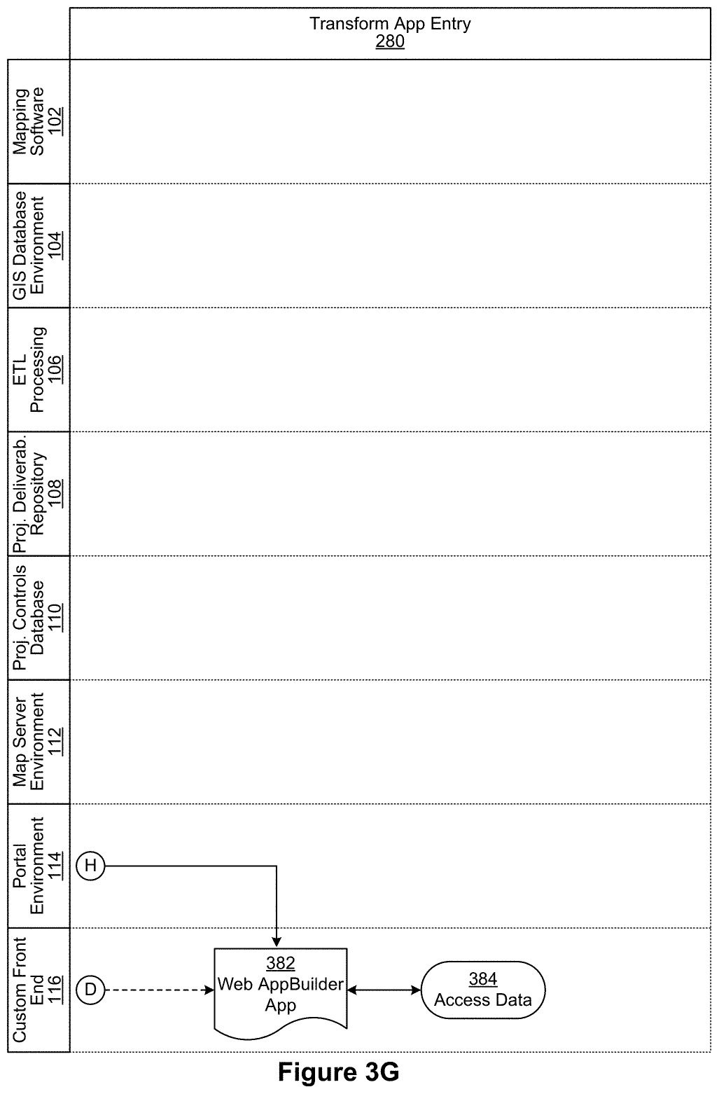

The mapping software 102 is configured to accept GIS data input from the field, upload the data to one or more servers, and perform quality assurance/control operations on the uploaded data in accordance with some implementations. The mapping software 102 may be implemented using one or more processors and memory storing one or more programs to be executed by the one or more processors, the one or more programs including instructions for executing operations 302, 312-314, and 352-354 as described in more detail below with reference to FIGS. 3A and 3D.

The GIS database environment 104 is configured to maintain one or more databases including both spatial data (e.g., GIS data) and associated non-spatial data (e.g., data ancillary to a project) in accordance with some implementations. The GIS database environment 104 may be implemented using one or more processors and memory storing one or more programs to be executed by the one or more processors, the one or more programs including instructions for executing operations 318, 342, and 346 as described in more detail below with reference to FIGS. 3A and 3C.

The ETL processing module 106 includes one or more processors configured to process spatial and non-spatial data in accordance with the type of data, the type of project, the intended use of the data, and so forth, in accordance with some implementations. The ETL processing module 106 may be implemented using one or more processors and memory storing one or more programs to be executed by the one or more processors, the one or more programs including instructions for executing operations 316, 322, 332, and 344 as described in more detail below with reference to FIGS. 3A-3C.

The project deliverables repository 108 includes non-spatial documents related to projects for storage in the GIS database environment 104 in accordance with some implementations. Such documents are configured to be linked to spatial data for associated projects. The project deliverables repository 108 may be implemented using one or more processors and memory storing one or more programs to be executed by the one or more processors, the one or more programs including instructions for executing operation 324 as described in more detail below with reference to FIG. 3B.

The project controls database 110 includes non-spatial control documents and/or data related to projects for storage in the GIS database environment 104 in accordance with some implementations. Such documents and/or data are configured to be linked to spatial data for associated projects. The project controls database 110 may be implemented using one or more processors and memory storing one or more programs to be executed by the one or more processors, the one or more programs including instructions for executing operation 334 as described in more detail below with reference to FIG. 3B.

The map server environment 112 includes a map server directory, an Environmental Systems Research Institute (ESRI) map server, and web proxies in accordance with some implementations. In some implementations, the map server directory is a third party map server directory. The map server environment 112 may be implemented using one or more processors and memory storing one or more programs to be executed by the one or more processors, the one or more programs including instructions for executing operations 356-357 as described in more detail below with reference to FIG. 3D.

The portal environment 114 includes internal and external web application configuration modules in accordance with some implementations. The portal environment 114 may be implemented using one or more processors and memory storing one or more programs to be executed by the one or more processors, the one or more programs including instructions for executing operations 358-359, 362-364, and 372-378 as described in more detail below with reference to FIGS. 3D-3F.

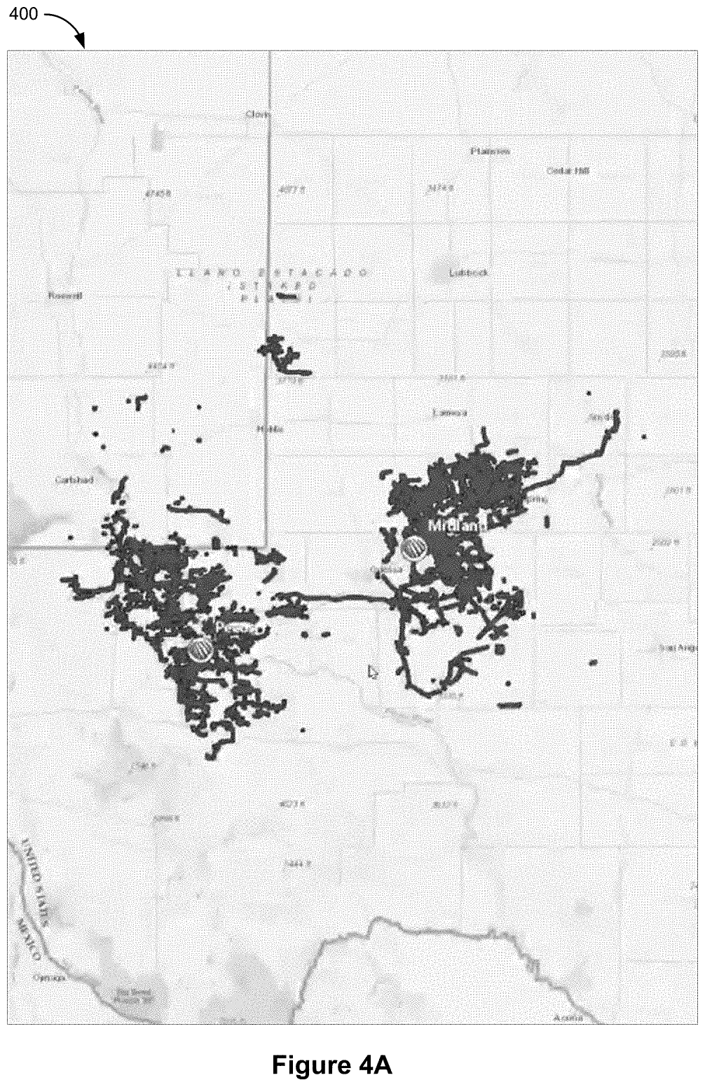

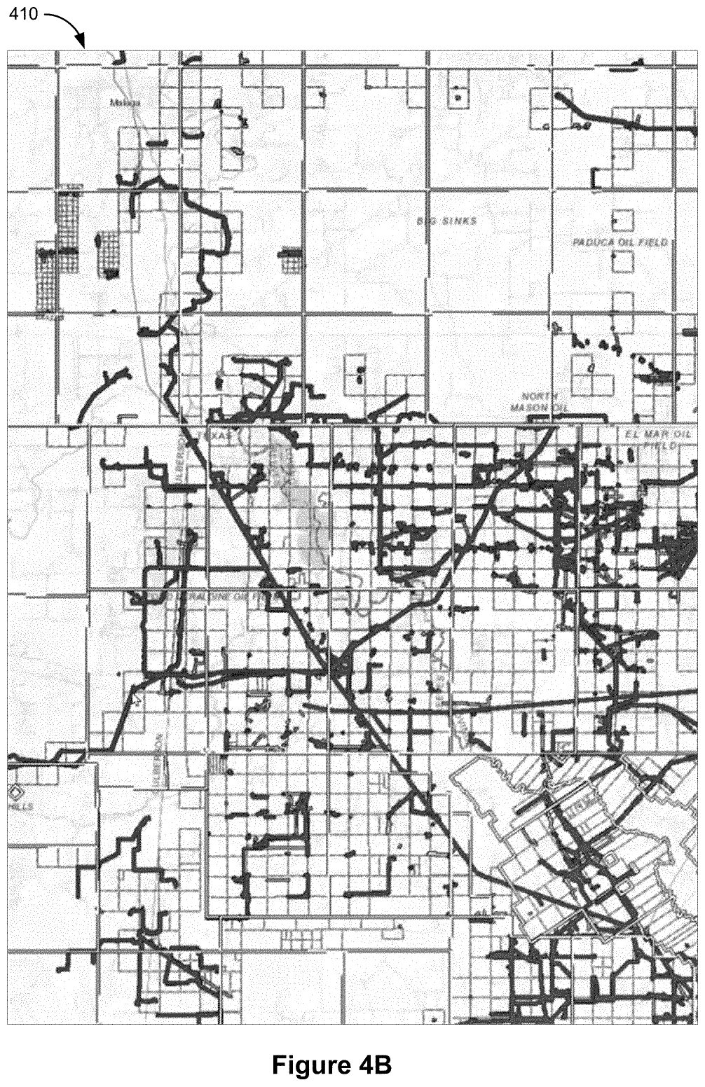

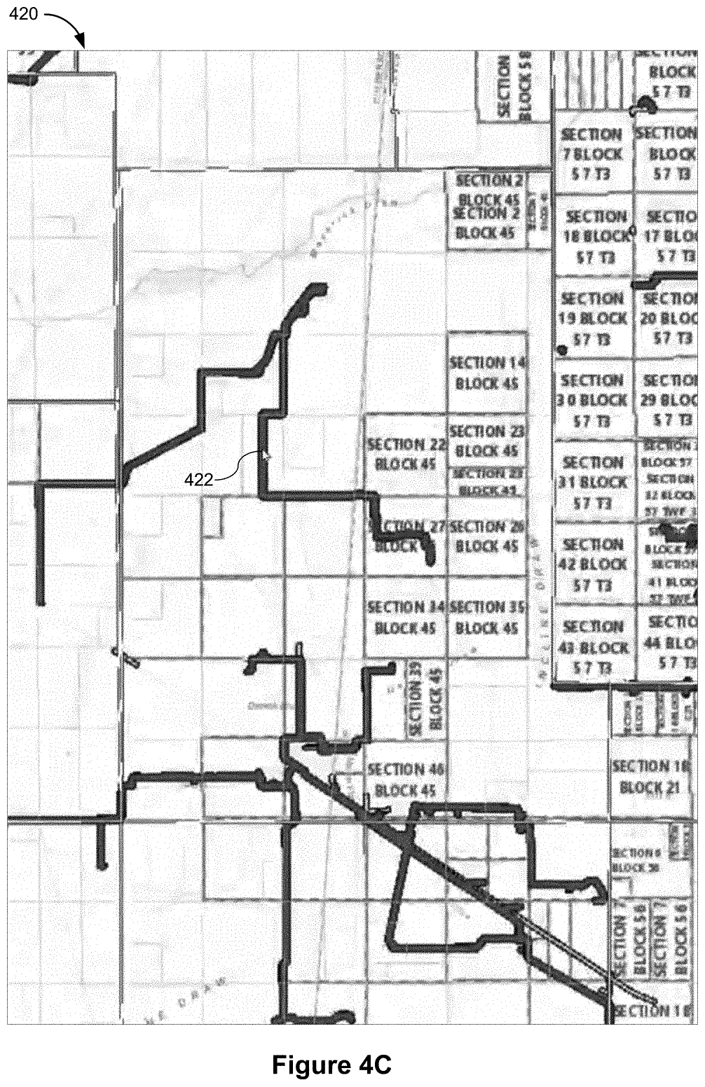

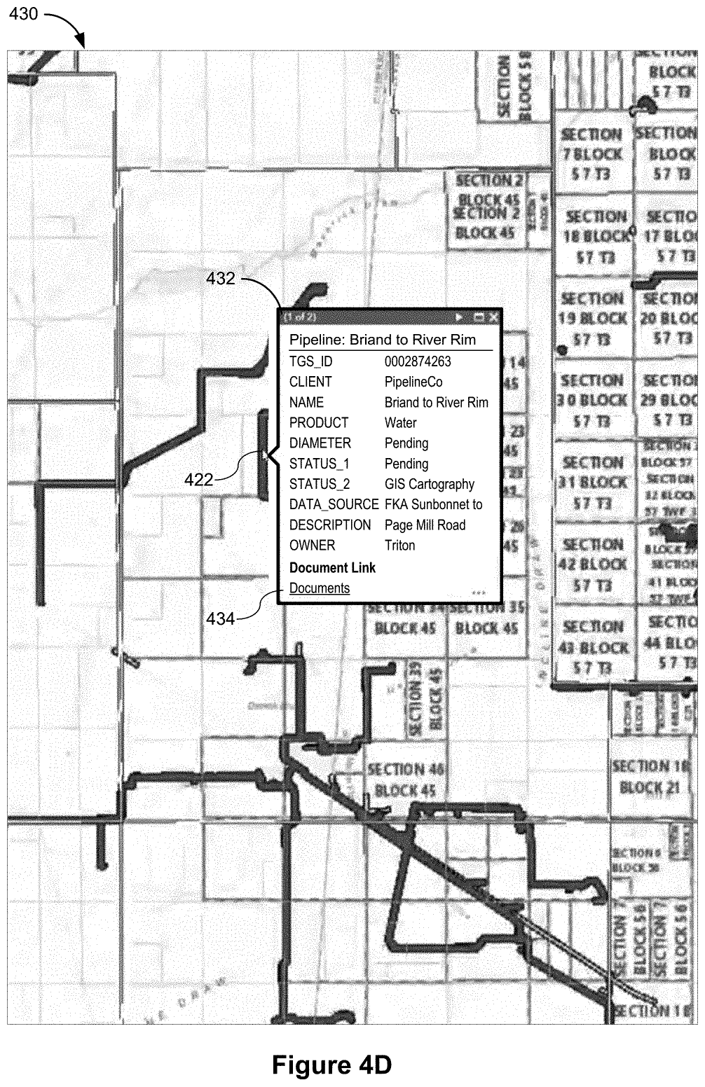

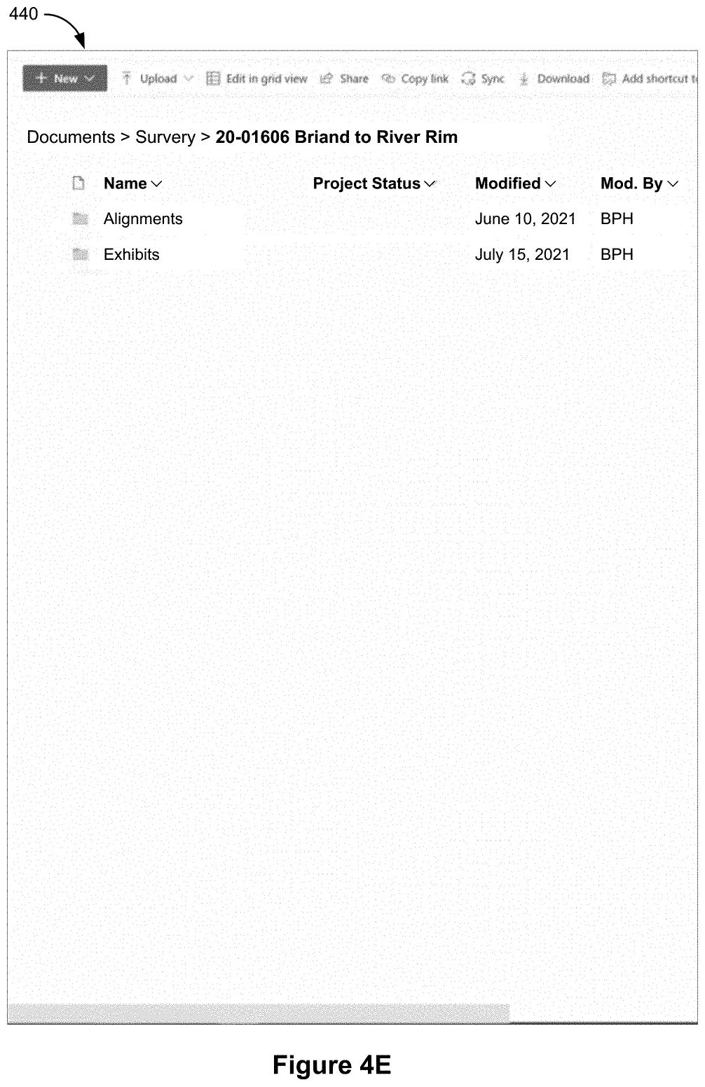

The custom front end 116 includes a transform application and user interface for displaying linked spatial and non-spatial data in accordance with some implementations. The custom front end 116 may be implemented using one or more processors and memory storing one or more programs to be executed by the one or more processors, the one or more programs including instructions for executing operations 382-384 as described in more detail below with reference to FIG. 3G. Example user interfaces implemented by the custom front end 116 are described in more detail below with reference to FIGS. 4A-4E.

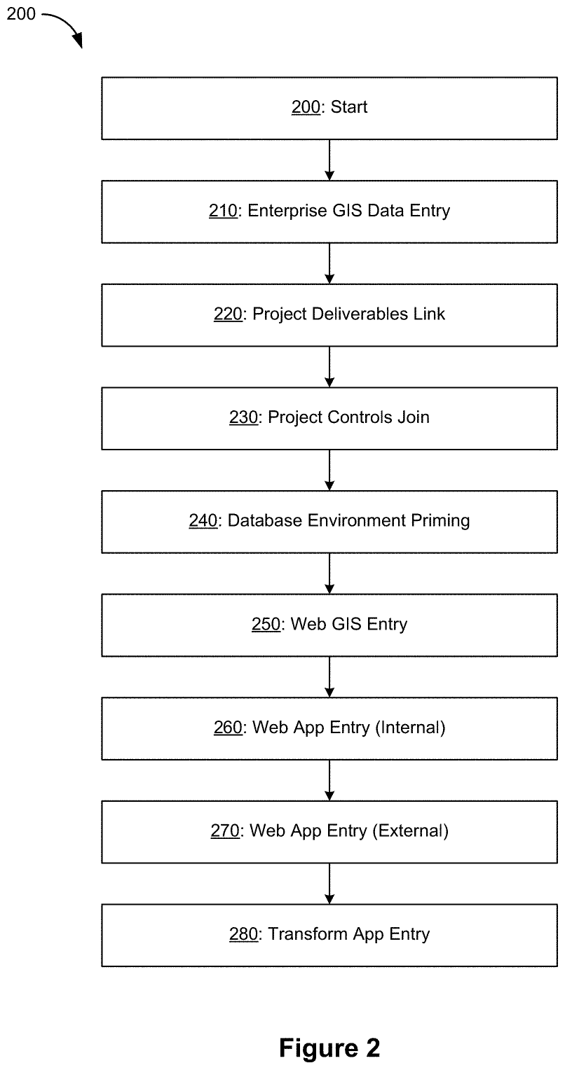

FIG. 2 is a flow diagram of a data processing method 200 in accordance with some implementations. Method 200 is, optionally, governed by instructions that are stored in computer memory or non-transitory computer readable storage mediums and that are executed by one or more corresponding processors. The computer readable storage mediums may include magnetic or optical disk storage devices, solid state storage devices such as Flash memory, or other non-volatile memory devices. The instructions stored on the computer readable storage mediums may include one or more of: source code, assembly language code, object code, or other instruction formats that are interpreted by one or more processors. Some operations in method 200 may be combined and/or the order of some operations may be changed.

In operation 200, spatial data collected in the field is obtained, and in operation 210, the data is subject to automated processing, including quality assurance/control, cleanup, and extract-transform-load (ETL) processing, before being uploaded to the GIS database in the form of a GIS record in accordance with some implementations. These operations are described in more detail below with reference to FIG. 3A.

In operation 220, non-spatial data projected deliverables data is linked to the GIS record, and in operation 230, non-spatial project control data is joined to the GIS record in accordance with some implementations. These operations are described in more detail below with reference to FIG. 3B.

In operation 240, the spatial and non-spatial data associated with the GIS record is primed for production and pushed for publishing in accordance with some implementations. These operations are described in more detail below with reference to FIG. 3C.

In operation 250, cartographically stylized map data associated with the GIS record is subjected to further processing and review, and the GIS record is published to a map server directory and web portal in accordance with some implementations. These operations are described in more detail below with reference to FIG. 3D.

In operation 260, the GIS record data is shared to an internal web application in accordance with some implementations. These operations are described in more detail below with reference to FIG. 3E.

In operation 270, the GIS record data is shared to an external web application in accordance with some implementations. These operations are described in more detail below with reference to FIG. 3F.

In operation 280, the GIS record data, configured ESRI web application (consisting of unique application configurations and tools), and links to corresponding non-spatial data are linked to a transform application and rendered in a user interface in accordance with some implementations. These operations are described in more detail below with reference to FIG. 3G.

FIGS. 3A-3G are flow diagrams of a data lifecycle associated with the data processing environment 100 (FIG. 1) and the data processing method 200 (FIG. 2) in accordance with some implementations.

Referring to FIG. 3A, the process begins with geospatial data (302) being obtained by internal processes at a first server. This data can be derived from surveys files, digitization, or receipt from third parties. The data may be processed using mapping software 102, which may be an application configured for manipulation and automation of the geospatial data, taking advantage of all of the data points that are collected, using different types of mapping applications.

Regarding the geospatial data (e.g., topographic data), such data may be obtained by data collectors (technicians, workers, employees, etc.) in the field using data collector devices (e.g., survey devices, topographic scanning devices, etc.), and uploaded using software in electronic communication devices (e.g., desktop computers, laptop computers, mobile devices, etc.).

The data collectors, using respective communication devices, may execute a synchronization function (e.g., by pushing a synchronize button in a user interface of a respective communication device) upon finishing the collection of data. When connected to network(s) 150 (e.g., the internet), the synchronization function synchronizes all of the collected geospatial data to the cloud-connected server running the mapping software 102.

In some implementations, the geospatial data is associated with a project and is collected using a code list in order to ensure that data points collected by data collectors are valid and useful for the project.

The data values specified by the code list may include property data, tract data, legal data, API data (data value identifier coordinates), infrastructure identifiers (e.g., an identifier for an oil well), company name, project identifier, people working on the project, equipment identifier (e.g., for servers, base stations, etc.), technician identifier, temperature data, topographic data (elevation, coordinates), and so forth.

The code list may be a specialized code list specifying a plurality of data values associated with a particular project, or a standard code list specifying a plurality of data values associated with a plurality of projects including the particular project.

For example, for a data collector device comprising a tripod and a sensing device mounted on the tripod, a technician would place the point of the tripod on a particular location, activate the sensing device (obtain a data point), and input additional information associated with that data point into a communication device, where that additional information is specified by the code list.

The code list may depend on the type of data being collected. For example, there may be different code lists for topographic data (e.g., a topo-point) vs. as-built data.

The code list may specify a plurality of data values (e.g., greater than, equal to, or more than 20 data values) to include for each shot (for each collected data point). For example, on an as-built pipeline, the code list may require the data collector to specify (i) the person who welded the joint, (ii) the humidity, and (iii) the temperature for each collected data point.

A standard code list may include data values required or requested by a plurality of clients (e.g., up to 100 clients or more). Such data values represent the data that each client, or a particular percentage of the clients, would like to collect for certain types of projects (or for all projects in general). As such, a standardized code list may be useful in that it could streamline the process of creating individual code lists for particular clients and/or projects.

For example, if a particular threshold (e.g., 20%) of clients want a particular feature included in their respective code lists, a standardized code list may include that feature for 100% of the clients using processing environment 100.

Upon being uploaded, the collected geospatial data may be subjected (312) to quality assurance/quality control (QA/QC) operations, whereupon data that passes (313) such operations is pushed to an ETL process (described in more detail below), and data that does not pass is subjected to a cleanup process (314).

In accordance with or in addition to the QA/QC process (e.g., for data that passes), the server parses the geospatial data, and classifies the parsed geospatial data, including identifying a project type of the first project based on one or more characteristics of the parsed geospatial data.

In some implementations, identifying the project type of the particular project associated with the geospatial data includes determining a type of job that was done based on a dataset associated with the parsed geospatial data.

In some implementations, identifying the project type of the particular project associated with the geospatial data includes determining that the first project is a topography project, an as-built project, or a scan file

Depending on the project type (i.e., depending on what the data is), the server sends the geospatial data to a particular extract-transform-load (ETL) module or tool, where it is further processed depending on what the data is. Example processing may include building a two-dimensional or three-dimensional model based on the geospatial data.

Up to the point, geospatial data is received, recognized, verified and quality controlled, and sent to a particular ETL process. For example, a topographic shot may be recognized, and the server may make sure that the data is verified and quality controlled as it needs to be for topography. As another example, scanned data (e.g., scans of power line poles or sag lines) may be received, and the server may recognize the type of data set from the different points associated with the scanned data, and send it to an ETL process optimized for the determined type of data set. As such, relevant technicians and/or departments may optionally be included in the data lifecycle.

In some implementations, the server selects a first ETL tool (316) of a plurality of ETL tools in accordance with the identified project type. The selected ETL tool processes the parsed geospatial data into a particular data scheme associated with the identified project type

Upon completion of the aforementioned ETL processing, the server upload the particular data scheme to a geospatial information system (GIS) database (318). The uploading may comprise storing the particular data scheme in the GIS database as a GIS record.

In some implementations, depending on which values were shot (i.e., the data that was collected) inside of the obtained field data, the ETL tool may (i) recognize the data values, (ii) select or change the processes are required to be executed on the data, and (iii) notify the proper departments to ensure that the proper people are actually working that data.

The GIS database may be a spatial database engine (SDE) database. SDE databases are configured to store geospatial data, and as such are optimized with spatial storage features (e.g., configured to store geospatial data, relationally).

In some implementations, one of the fields associated with the GIS record includes a document link (e.g., a URL) for display in the user interface of the custom front end 116, described in more detail below. By selecting the document link in the user interface, a document management system opens, allowing users to view documents corresponding to the particular project associated with the GIS record.

For example, a user may view a project geospatially on the front end (as described below with reference to FIGS. 4A-4D), click on an asset (e.g., FIG. 4D), and open a document management system (FIG. 4E) in order to view certificates, surveys, data, and deliverables associated with the project.

Referring to FIG. 3B, the process continues by linking/joining non-spatial project deliverable documents (322) stored in a document center database (324) to the GIS record in the GIS database.

The non-spatial project deliverable documents are associated with the particular project that the geospatial data is associated with. The non-spatial project deliverable documents may include nonspatial records and any other ancillary data associated with the project. The ancillary data may correspond to an asset (e.g., a pipeline) associated with the first project.

The front end 116 not only uses the geospatial data corresponding to the GIS record (e.g., to determine where to position elements in a map displayed in the user interface), but also links the geospatial data to this nonspatial data (e.g., the document link 434 in FIG. 4D).

In some implementations, linking the one or more non-spatial project deliverable documents to the GIS record includes creating a link in the GIS database between (i) an SDE table including coordinates associated with the first data scheme of the GIS record, and (ii) a second table including a pointer to the one or more non-spatial project deliverable documents (e.g., a document center URL).

As such, when a user selects an asset in the user interface of the front end, the user interface proceeds to display both the SDE data and the corresponding ancillary data (e.g., document center link).

In some implementations, the process continues by linking/joining project controls data (332) stored in a project controls database (334) to the GIS record in the GIS database. Project controls may include data that is associated with a plurality of projects, and in some instances may include data that is used in all of the projects. Example project controls may include a project identifier, an opportunity identifier.

At this point in the process, all of the project deliverables that have been obtained from the project management system, and all of the data for the project from the project management software are joined together. As such, not only does the processing environment 100 contain all of the geospatial data for a given project, but also everything that has been done with the given project as well, brought together to be provided to a user via the front end 116.

Referring to FIG. 3C, the process continues with database environment priming. Specifically, the operations of the process up to this point have been executed in one or more servers (e.g., one or more SQL servers).

Once the geospatial and non-spatial data is ready to be pushed to production after final edits to the GIS database (342) (e.g., to ensure all changes to the data are correct and there are no errors), the data (e.g., the GIS record) is pushed to a production database (e.g., an enterprise database) for publishing (344). The data may also be published at the GIS database (346).

Referring to FIG. 3D, the process continues with a web GIS entry. The mapping software creates one or more map exchange document (MXD) files corresponding to the published GIS record and reviews the MXD files (352).

If the MXD files do not pass the review (353), the underlying data may be provided back to the GIS database for further editing (318, FIG. 3A).

If the MXD files do pass the review (353), the underlying data may be published to a map server directory (356) of the map server environment 112 as a map service, and conveyed to the network(s) 150 via a proxy server (357).

The map services contain map data, specifics about the GIS data used (including pointers to the file location for each dataset), display information (symbology and labeling), and other elements used in mapping software (e.g., used in ArcMap).

The map service data is viewable in the user interface of the front end 116 at varying levels of detail and zoom. The map service data may be combined into a single user interface element associated with a particular asset or feature of interest, and displayed on top of a map including a plurality of user interface elements associated with a plurality of assets (e.g., user interface element 422, FIG. 4C).

The user interface element may be zoomed in to provide a closer version of a point of interest (as shown in FIG. 4C), or zoomed out across larger geographic areas, showing a plurality of different points of interest (as shown in FIGS. 4A and 4B). For example, a single map view may include 20-30 different wells.

The process continues with the map service in the map server being pushed to a map server directory (356) prior to being deployed to a web service via a proxy server (357).

The proxy server 357 shares the map service data to an internal portal (358) (e.g., an ESRI portal). As such, the map directories may be set up based on a web service server (loaded with all of the data of the web services) and a portal (the interface that uses the web services). The web services obtain the map service data and provide it to the front end 116 later in the process. The internal portal provides the map service data via a proxy server (359).

Referring to FIG. 3E, the process continues with internal web application entry operations. The internal web application entry operations include a web application configuration module (362) configured to populate a web application template that provides a majority of elements of the viewable user interface. Stated another way, the configuration module (362) configures a web application including the one or more map services.

These elements mainly consist of user interface elements that may be used for a plurality of projects and/or clients, regardless of the specific data. Such elements may be further customized (e.g., with branding, colors, and so forth) in accordance with individual clients. The web application template is built using an internal web application builder (364).

Referring to FIG. 3F, the process continues with external web application entry operations. The web application is shared with an external portal (372) associated with an external group (e.g., a client group). The web application is provided via an external portal (374) (e.g., an external ESRI portal) and a proxy server (376) to an external web application builder (378).

Referring to FIG. 3G, the process continues with transform application entry operations. Such operations provide access to the geospatial and non-spatial data associated with a selected asset via a user interface constructed by a web application builder (382) at the custom front end 116. The client may access such data (384) using the web application constructed by the web application builder (382).

Stated another way, the process continues by creating a transform application based on the web application, wherein the transform application comprises a user interface including map data associated with the map services, and a plurality of selectable user interface elements, wherein each of the plurality of selectable user interface elements corresponds to a selectable portion of the map data and includes (i) spatial data associated with the GIS record (obtained via path H, originating in FIG. 3F), and (ii) a link to the one or more non-spatial project deliverable documents associated with the GIS record (obtained via path D, originating in FIG. 3B).

FIG. 4A-4E are diagrams of geographic information system visualization interfaces in accordance with some implementations.

The custom front end 116 uses the databases as described above to plot a plurality of assets on a map, and integrate non-spatial information associated with each asset (e.g., name, client, status, data source, document links, and so forth) in, for example, a popup user interface element (e.g., popup window 432, FIG. 4D).

FIG. 4A depicts a zoomed out map interface 400 including two clusters of assets or points of interest corresponding to collected geospatial data. FIG. 4B depicts a zoomed in map interface 410, including a detailed view of one of the two clusters depicted in map interface 400. FIG. 4C depicts a zoomed in map interface 420, including an even more detailed view of a portion of the zoomed in cluster depicted in interface 410.

Each darkened line in FIGS. 4A-4C represents a geospatial asset, or a portion of a geospatial asset. By selecting a line segment (e.g., segment 422), a portion of a particular asset corresponding to the selected line segment is selected for viewing, and a popup window is displayed including the associated geospatial and non-spatial data corresponding to the project and asset associated with the selected line segment.

FIG. 4D depicts a map interface 430 corresponding to the map interface 420 and including an example popup window 432, which includes the geospatial and non-spatial data corresponding to the project and asset associated with the selected line segment 422. A documents link 434 is included in the window 432, the selection of which navigates the user to a document list interface including links to documents associated with the project and asset corresponding to the selected line segment.

FIG. 4E depicts an example document list interface 440. The document list interface 440 is directly linked from the map interface 430 upon selection of the document link in the popup window 432.

By using the custom front end 116 in the manner described above, a user may look at a given project geospatially, select an asset, and open a document management system directly linked to the selected asset on the geospatial map interface, providing efficient access to documents such as certificates, surveys, data, and deliverables corresponding to the project.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims.

For example, specific features of the exemplary embodiments may or may not be part of the claimed invention, different components as opposed to those specifically mentioned may perform at least some of the features described herein, and features of the disclosed embodiments may be combined.

As used herein, the terms “about” and “approximately” may refer to + or −10% of the value referenced. For example, “about 9” is understood to encompass 8.2 and 9.9.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

It will be understood that, although the terms “first,” “second,” etc. are sometimes used herein to describe various elements, these elements should not be limited by these terms. These terms are only used to distinguish one element from another.

For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

As used herein, the term “if” may be, optionally, construed to mean “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The terminology used herein is for the purpose of describing particular implementations only and is not intended to be limiting of the claims.

As used in the description of the implementations and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items.

It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context.

Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A method comprising:
at one or more servers, each of the one or more servers comprising one or more processors and memory:
obtaining geospatial data collected from a field device and associated with a first project, wherein the data is obtained in accordance with a code list specifying a plurality of data values associated with a plurality of projects including the first project;
parsing the geospatial data in accordance with one or more quality control operations;
classifying the parsed geospatial data, including identifying a project type of the first project based on one or more characteristics of the parsed geospatial data;
selecting a first extract-transform-load (ETL) tool of a plurality of ETL tools in accordance with the identified project type;
processing, using the selected ETL tool, the parsed geospatial data into a first data scheme;
uploading the first data scheme to a geospatial information system (GIS) database, including storing the first data scheme in the GIS database as a GIS record;
linking one or more non-spatial project deliverable documents to the GIS record in the GIS database, wherein the non-spatial project deliverable documents are associated with the first project;
joining one or more project controls to the GIS record in the GIS database;
creating one or more map exchange document (MXD) files corresponding to the GIS record;
publishing the GIS record from the one or more MXD files to one or more map services;
configuring a web application including the one or more map services; and
creating a transform application based on the web application, wherein the transform application comprises a user interface including map data associated with the one or more map services, and a selectable user interface element, wherein the selectable user interface element corresponds to a selectable portion of the map data and includes (i) spatial data associated with the GIS record, and (ii) a link to the one or more non-spatial project deliverable documents associated with the GIS record.

2. The method of claim 1, wherein the geospatial data includes topographical data.

3. The method of claim 2, wherein the data values of the code list include one or more of coordinates, equipment identification data, technician identification data, and temperature data.

4. The method of claim 3, wherein identifying the project type of the first project includes determining a type of job that was done based on a dataset associated with the parsed geospatial data.

5. The method of claim 4, wherein identifying the project type of the first project includes determining that the first project is a topography project, an as-built project, or a scan file.

6. The method of claim 5, wherein linking the one or more non-spatial project deliverable documents to the GIS record includes creating a link in the GIS database between (i) a first table including coordinates associated with the first data scheme of the GIS record, and (ii) a second table including a pointer to the one or more non-spatial project deliverable documents.

7. The method of claim 6, wherein the one or more non-spatial project deliverable documents include ancillary data corresponding to an asset associated with the first project.

8. The method of claim 6, wherein the one or more project controls include data that is associated with each of the plurality of projects.

9. The method of claim 6, wherein:
the one or more non-spatial project deliverable documents include ancillary data corresponding to an asset associated with the first project; and
the one or more project controls include data that is associated with each of the plurality of projects.

10. A system configured to process geospatial information system (GIS) data, the system comprising:
one or more processors; and
memory storing one or more programs for execution by the one or more processors, the one or more programs comprising instructions for:
obtaining geospatial data collected from a field device and associated with a first project, wherein the data is obtained in accordance with a code list specifying a plurality of data values associated with a plurality of projects including the first project;
parsing the geospatial data in accordance with one or more quality control operations;
classifying the parsed geospatial data, including identifying a project type of the first project based on one or more characteristics of the parsed geospatial data;
selecting a first extract-transform-load (ETL) tool of a plurality of ETL tools in accordance with the identified project type;
processing, using the selected ETL tool, the parsed geospatial data into a first data scheme;
uploading the first data scheme to a geospatial information system (GIS) database, including storing the first data scheme in the GIS database as a GIS record;
linking one or more non-spatial project deliverable documents to the GIS record in the GIS database, wherein the non-spatial project deliverable documents are associated with the first project;
joining one or more project controls to the GIS record in the GIS database;
creating one or more map exchange document (MXD) files corresponding to the GIS record;
publishing the GIS record from the one or more MXD files to one or more map services;
configuring a web application including the one or more map services; and
creating a transform application based on the web application, wherein the transform application comprises a user interface including map data associated with the one or more map services, and a selectable user interface element, wherein the selectable user interface element corresponds to a selectable portion of the map data and includes (i) spatial data associated with the GIS record, and (ii) a link to the one or more non-spatial project deliverable documents associated with the GIS record.

11. The system of claim 9, wherein the geospatial data includes topographical data.

12. The system of claim 10, wherein the data values of the code list include one or more of coordinates, equipment identification data, technician identification data, and temperature data.

13. The system of claim 11, wherein identifying the project type of the first project includes determining a type of job that was done based on a dataset associated with the parsed geospatial data.

14. The system of claim 12, wherein identifying the project type of the first project includes determining that the first project is a topography project, an as-built project, or a scan file.

15. The system of claim 13, wherein linking the one or more non-spatial project deliverable documents to the GIS record includes creating a link in the GIS database between (i) a first table including coordinates associated with the first data scheme of the GIS record, and (ii) a second table including a pointer to the one or more non-spatial project deliverable documents.

16. The system of claim 14, wherein the one or more non-spatial project deliverable documents include ancillary data corresponding to an asset associated with the first project.

17. The system of claim 14, wherein the one or more project controls include data that is associated with each of the plurality of projects.

18. The system of claim 14, wherein:
the one or more non-spatial project deliverable documents include ancillary data corresponding to an asset associated with the first project; and
the one or more project controls include data that is associated with each of the plurality of projects.
